(19) United States
(12) Patent Application Publication
(10) Pub. No.: US 2008/0309063 A1
(43) Pub. Date: Dec. 18, 2008

(54) Microrefraction Image

(76) Inventor: Joerg Zintzmeyer, Maennedorf (CH)

Correspondence Address: CARLSON, GASKEY & OLDS, P.C., 400 WEST MAPLE ROAD, SUITE 350, BIRMINGHAM, MI, 48009, US

(21) Appl. No.: 12/064,055

(22) PCT Filed: Aug. 14, 2006
(86) PCT No.: PCT/EP2006/008038

§ 371 Date: Jul. 1, 2008

(30) Foreign Application Priority Data
Aug. 18, 2005 (DE) 10 2005 039 113.3

(51) Int. Cl. B42D 15/10; B44C 1/24

(52) U.S. Cl. 283/72; 101/32

(57) ABSTRACT

A periodic line pattern, which is covered by a periodic lens structure of cylindrical lenses parallel to the lines of the line pattern, is imprinted on a substrate. The period of the lens structure corresponds with the period of the line pattern. The lenses preferably are aligned flush with the lines of the line pattern. The lines consist of paths of elementary printing dots or image dots (pixels). The number of paths of elementary printing dots in one period is at least 4 and not more than 16. The height of the cylindrical lenses at the apex is at least half the width of a period and not more than the width of a period of the line pattern. With advanced offset printing methods, which are employed for instance in safety printing (e.g. for banknotes), a printing resolution of about 4 μm is achieved. Preferably, the elementary printing dots are chosen only a little larger than the achievable printing resolution. What is realistic are elementary printing dots of approximately square shape with a side length between 4 and 8 μm. With minimum requirements as to the design possibilities for the line pattern, two lines per period are sufficient. Each line should consist of at least two paths of elementary printing dots. This corresponds to a period width of about 40 μm. In the corresponding lens structure, the individual cylindrical lenses have a height at the apex of slightly more than half the period width. Such fine lens structures can be produced by imprinting a transparent mass with an intaglio printing method or by embossing the transparent mass with an intaglio gravure plate. The microrefraction image thus obtained is particularly useful for use in a certificate of authenticity.

### RELATED APPLICATIONS

The application is the U.S. National Phase of PCT/EP/2006/008038, filed 14 Aug. 2006, which claims priority to DE 10 2005 039 113.3, filed 18 Aug. 2005.

### BACKGROUND OF THE INVENTION

This invention relates to a microrefraction image, a method of producing the same, and a certificate of authenticity.

Refraction images consist of a periodic line pattern, which is applied on a substrate, and of a lens structure of cylindrical lenses parallel to the lines of the line pattern, which covers the line pattern. Depending on the viewing angle under which the periodic line pattern is observed through the lens structure, different lines are visible in each period of the line pattern, which together provide the image perceived. By means of the configuration of the line pattern, various optical effects can be achieved, as a result of which the viewer perceives different image contents at different viewing angles. The effects dependent on the viewing angle can consist in a change in color, a change in shape or a combination of change in color and change in shape.

Conventional refraction images can be used as safety features in certificates of authenticity or securities. However, they are not particularly counterfeit-proof, because they have a relatively coarse structure. For the optical effect of a refraction image it is necessary that the lens structure is applied over the periods of the line pattern exactly congruent or at least parallel and with a constant offset. In the prior art, the lens structures are produced by extruding transparent plastic material or by mechanical deformation. With such a production method, lens structures can be achieved, in which the lens width is hardly smaller than a few tenths of a millimeter. The underlying line pattern then is correspondingly coarse.

### SUMMARY OF THE INVENTION

The invention creates a microrefraction image, which due to the high fineness of its line pattern makes counterfeiting almost impossible.

The microrefraction image of the invention comprises a substrate, a periodic line pattern imprinted on the substrate, and of a periodic lens structure of cylindrical lenses parallel to the line pattern, which covers the line pattern. The period of the cylindrical lenses corresponds with the period of the line pattern. Preferably, but not necessarily, the lenses are aligned flush with the lines of the line pattern. The lines comprise paths of elementary printing dots or image dots (pixels). The number of the paths of elementary printing dots in one period lies between about 4 and 16. The height of the cylindrical lenses at the apex lies in a range from half the width of a period to about the width of a period of the line pattern. With advanced offset printing methods, which are used for instance in safety printing (e.g. for banknotes), a printing resolution of about 4 μm is achieved. Preferably, the elementary printing dots are chosen only a little larger than the achievable printing resolution. What is realistic are elementary printing dots of approximately square shape with a side length between 4 and 8 μm, in particular 6 μm or slightly more. With minimum requirements as to the design possibilities for the line pattern, two lines per period are sufficient. Each line should comprise at least two paths of elementary printing dots. This corresponds to a period width of about 40 μm. In the corresponding lens structure, the individual cylindrical lenses have a height at the apex of preferably slightly more than half the period width. Such fine lens structures can be produced by imprinting a transparent mass with an intaglio printing method or by embossing the transparent mass with an intaglio gravure plate.

In the case of high demands as to the design possibilities for the refraction image, the periodic line pattern has a maximum number of lines, which is determined by the possibilities of the intaglio method for producing the lens structure. For a good refraction effect, the cylindrical lenses must be dimensioned square or oversquare with a semicircular or parabolic cross-sectional shape (i.e. their height at the apex is at least equal to half the period width). With the intaglio technique, structures with a relief height up to about 100 μm or more can be produced. Taking into account a small distance between adjacent lenses, and depending on the cross-sectional shape of the lenses, a period width of the line pattern of up to about 220 μm is obtained thereby. A great variety of design possibilities is obtained with a line pattern with seven lines per period, with each line comprising two paths of printing dots. With the same period width, two lines of seven paths each or also fourteen lines of only one path each likewise are possible.

Thus, the invention combines two printing techniques, each of which is used just within its capabilities: on the one hand, the inexpensive offset printing method, whose printing resolution is fully exhausted, and on the other hand the likewise inexpensive intaglio method, which because of the limited relief heights that can be produced therewith can be used for creating the appropriate lens structures only because the line patterns produced with the described high-precision offset printing have an extraordinarily fine structure and hence a correspondingly small period width.

For colored refraction effects, the lines within one period of the line pattern have different colors. For imprinting lines of different colors with a high dimensional accuracy, simultaneous offset printing can be used.

When an optical effect with a sudden change of the image content with a small change of the viewing angle is desired, cylindrical lenses with a prismatic cross-sectional shape are used.

Novel optical refraction image effects are possible when the line patterns and the lens structure have congruent surface regions, in which the direction of extension of the lines or lenses is different from the direction of extension in at least one other surface region.

Subject-matter of the invention also is a method for producing a microrefraction image. According to the method of the invention, a periodic line pattern is imprinted on a substrate by precision offset printing. Then, a lens structure is applied over the line pattern in a transparent mass by intaglio printing or by embossing the transparent mass with an intaglio gravure plate. The combination of simultaneous offset printing, whose capabilities in terms of printing resolution are fully utilized, with the intaglio technique for applying the lens structure over the line pattern provides for producing extremely complex and high-resolution refraction images with a variety of optical effects at low cost.

For the proper optical function it is required that the cylindrical lenses of the lens structure are superimposed largely congruent on the periods of the line pattern or at least have a constant offset over the entire extension of the refraction image. Although different printing methods are used for applying the line pattern and producing the lens structure, it is possible to achieve the required dimensional accuracy between line structure and lens structure. For this purpose, the same dimensional basis is used in particular for manufacturing the printing plate for precision offset printing and for manufacturing the intaglio gravure plate. In both cases, laser technology is used. For manufacturing the printing plate for offset printing, a laser exposure method is employed. For manufacturing the intaglio gravure plate, a laser method with ablation, in particular by evaporation, is employed directly on the surface of the printing plate.

In an advantageous embodiment, the substrate comprises a transparent material. The lens structure is arranged on the one surface and the line structure on the other surface of the substrate facing away therefrom. The distance between line pattern and lens structure due to the thickness of the substrate promotes the achievable optical effects.

Subject-matter of the invention furthermore is a certificate of authenticity with at least one safety element, which is applied on a substrate and has a periodic line structure, and with a periodic lens structure of parallel cylindrical lenses, which covers the safety element. The period of the lens structure each corresponds with the period of the line structure, and the lenses are aligned with the periodic line structure of the safety element. Furthermore, the height of the cylindrical lenses at the apex above the safety element is at least half the width of a period and, in one example, not more than the width of a period. The certificate of authenticity in accordance with the invention is so complex that counterfeiting hardly is possible. Possible counterfeits can easily be visually recognized without any technical aids.

In one embodiment of the certificate of authenticity, two safety elements are arranged on the same substrate. In a transition zone, the same are connected by superposition, so that a visually verifiable interconnection of the two safety elements is obtained. The interconnection can be, for instance, that when changing the viewing angle, a strip or the like highlighted by color continuously moves out of the one safety element through the transition zone into the other safety element. The safety elements can be the microrefraction images described above, but also different safety elements such as holograms, colorgrams or kinigrams. One of the safety elements can be determined by a product supplier and the other one by a certification authority, which issues the certificate of authenticity.

Another advantageous embodiment of the certificate of authenticity consists in that it is composed of a plurality of layers, one of which is equipped with adhesion properties with respect to a product to be protected, and at least one further layer, whose removal will destroy the certificate, is preperforated or prepunched along predetermined tear lines. Such certificate of authenticity has the function of a seal.

Further advantages and features of the invention can be taken from the following description of preferred embodiments with reference to the attached drawings.

### BRIEF DESCRIPTION OF THE DRAWINGS

FIG. 1 shows a perspective illustration of the variations of a microrefraction image under different viewing angles;

FIG. 2 shows a top view of a microrefraction image;

FIG. 2a shows a greatly enlarged detailed view of the microrefraction image of FIG. 2;

FIG. 3 shows a greatly enlarged sectional view of a lens structure of parallel cylindrical lenses associated to a periodic line pattern of a relatively large period width;

FIG. 4 shows a greatly enlarged sectional view of a lens structure of parallel cylindrical lenses associated to a periodic line pattern of a relatively small period width;

FIGS. 5a to 5g show enlarged sectional views of a lens structure of parallel cylindrical lenses of different cross-sectional shapes;

FIGS. 6a to 6e show top views of different configurations of lens structures with parallel cylindrical lenses;

FIG. 7 shows a top view of a certificate of authenticity with two safety elements and a transition region interconnecting the same;

FIG. 8 shows a top view of an authentication seal with preperforated or prepunched tear lines;

FIG. 9a and FIG. 9b show schematic sectional views for illustrating an alternative embodiment and its manufacture.

### DETAILED DESCRIPTION OF THE PREFERRED EMBODIMENT

In FIG. 1, reference numeral 10a designates a perspective view of a greatly enlarged section of a microrefraction image under a certain viewing angle. The same section of the microrefraction image is shown in FIG. 1 beside the same with reference numeral 10b under a viewing angle rotated by about 90°. Below the same, FIG. 1 shows three forms of the microrefraction image at 12a, 12b and 12c, as they are presented to the viewer when the viewing angle is changed from the situation shown at 10a to the situation shown at 10b. The form designated with 12a is a combination of a letter “S” with the numeral “1”. The form designated with 12c is a combination of a letter “H” with the numeral “1”. The intermediate form 12b is a state of transition between the forms 12a and 12c, the transitions being fluent.

Refraction images of this kind are known in principle. They comprise a periodic line pattern applied on a substrate and of a lens structure of cylindrical lenses parallel to the lines of the line pattern, which covers the line pattern and whose width corresponds with the period width of the line pattern.

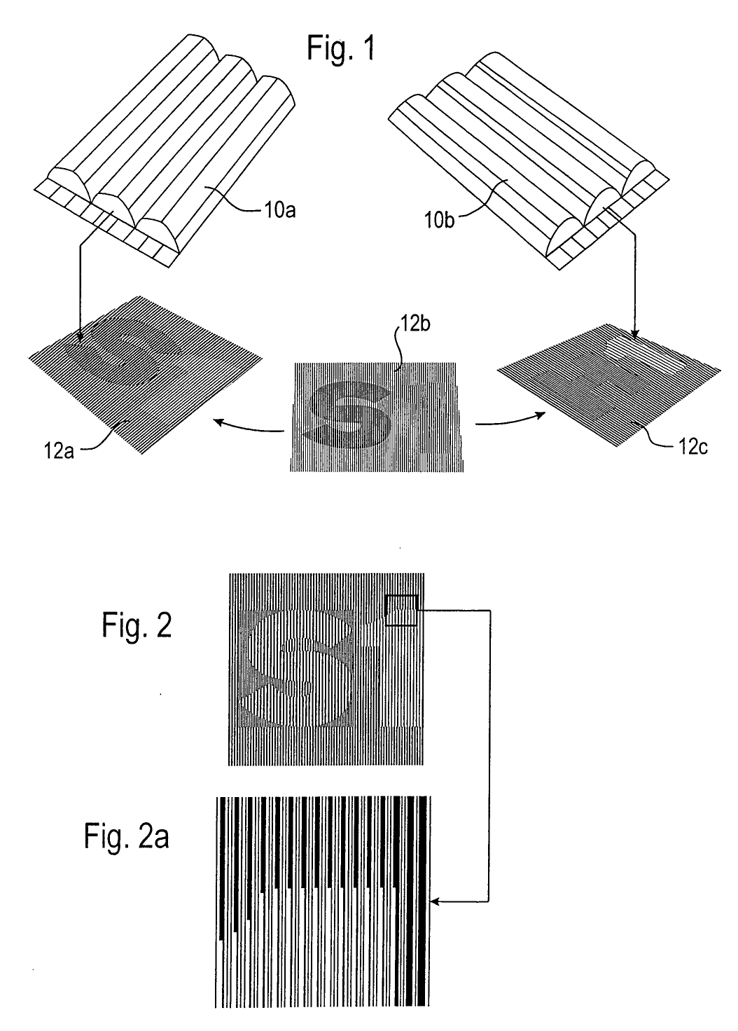

As can be taken from the vertical top view of the exemplary microrefraction image shown in FIG. 2, and more accurately from the detailed view of FIG. 2a, the same comprises a multitude of parallel line portions of different lengths, wherein in each period of the line pattern the lines can have different colors, e.g. the colors red, green and blue in a line pattern with three colors.

One of the particularities of the invention is the extraordinary fineness of the line pattern and the lens structure. In accordance with the invention, two printing methods known per se are used for realizing such high-resolution microrefraction images, but each of them separately just within its capabilities. The line pattern is imprinted on a substrate by offset printing with a realistic printing resolution of about 4 μm. When the lines in each period each should have different colors, simultaneous offset printing will be used. On top of this, the lens structure is imprinted by intaglio printing from a transparent paste.

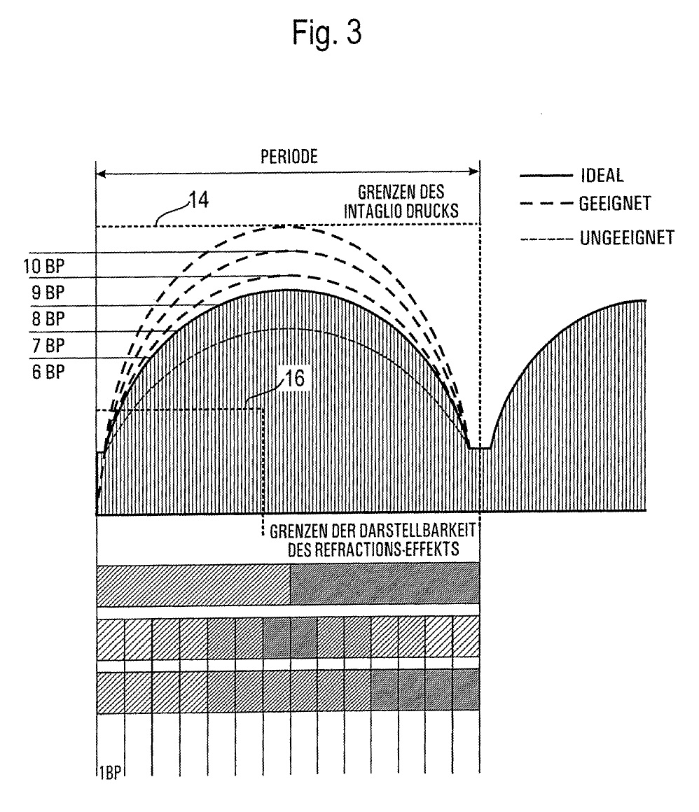

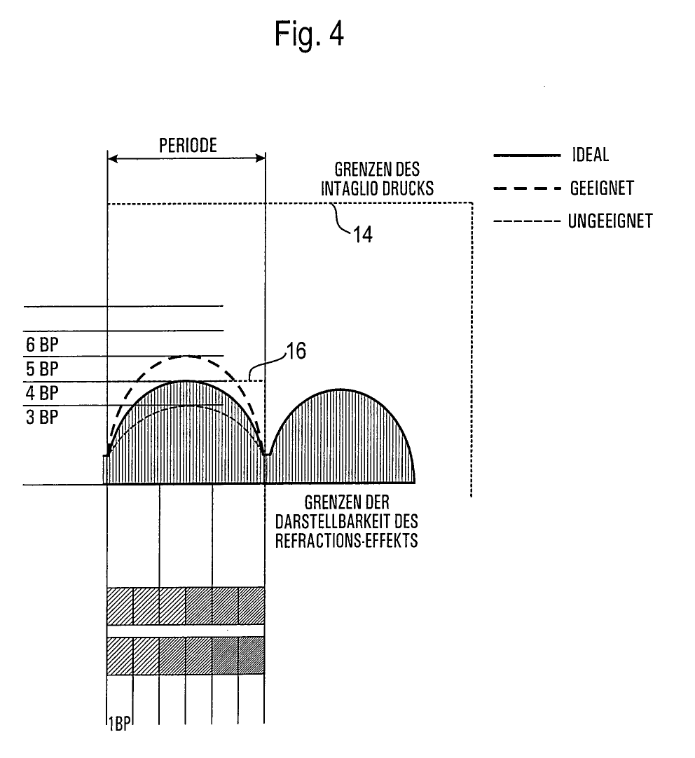

For the desired refraction effect, the cylindrical lenses must have an apex height above the line pattern, which corresponds to about half the period width of the line pattern or is slightly larger. However, the structure heights possible with intaglio printing are limited. Accordingly, the maximum possible period width of the line pattern is determined by the capabilities of intaglio printing, whereas the fineness of the line pattern is limited by the capabilities of offset printing. These facts should be explained in detail below with reference to FIGS. 3 and 4. In these Figures, “IP” designates an elementary image dot, which is assumed to be ideally square with a side length of not much more than the achievable printing resolution of about 4 μm, for instance a side length of slightly more than 6 μm.

In FIGS. 3 and 4, a limit of the structures to be realized with intaglio printing is schematically represented by a first dotted line 14. It has a structure height of about 12 image dots IP and a structure width of about 14 image dots IP. A second dotted line 16 schematically represents a limit of the fineness of a line pattern to be realized with offset printing. Within these borderlines, the method of the invention for producing a microrefraction image can optimally be performed. In FIG. 4, however, it is assumed that each period of the line pattern has three lines and each line has a width of two image dots IP. If a line pattern with only two lines per period is accepted, the borderline 16 is reduced to merely four image dots IP. Furthermore, in FIG. 3 the structure width of fourteen image dots with a maximum structure height of twelve image dots IP results from the request for an oversquare cross-sectional shape of the cylindrical lenses (i.e. the apex height is greater than half the structure width). However, if a square cross-sectional shape of the cylindrical lenses is also accepted, the corresponding structure width of the line pattern is sixteen instead of fourteen image dots IP.

It will be appreciated that these values require available printing techniques. With increasing capabilities of offset printing, the line patterns can become even finer and the lens structures can become even higher.

FIG. 3 shows the cross-section of a lens structure over a line pattern, which comprises fourteen parallel and adjoining printed paths with a width of one printing dot IP each. When each line of the line pattern has two such printed paths, each period of the line pattern has seven lines, which can have different colors. Alternatively, each line of the line pattern for instance has only two lines, which each have seven printed paths with a width of one IP, or also any combination of printed paths.

FIG. 3 furthermore illustrates various possible cross-sectional shapes of the cylindrical lenses. For an optimum refraction effect, the cross-sectional shape should be “oversquare”, i.e. the apex height should be greater than half the period width. However, since the capabilities of intaglio printing are limited in terms of structure height, a compromise of about ⅝ of the period width as apex height (corresponding to 8.75 image dots) is regarded as particularly favorable. This cross-sectional shape is illustrated in FIG. 3 with a continuous line. Less ideal cross-sectional shapes are illustrated in FIG. 3 with broken lines. The period width of the lens structure is obtained from the width of the lenses and the width of the small distance between adjacent lenses. The same is advantageous for two reasons: on the one hand, sharp edges thus are avoided on the intaglio gravure plate, which might cut into the substrate; on the other hand, in intaglio printing the wiping process is promoted, by which the transparent paste is wiped off the raised surfaces of the gravure plate after having been applied onto the same. The distance between adjacent lenses only is about one image dot or only a few image dots.

With the period width of the line pattern of fourteen image dots assumed in FIG. 3 and with the optimum cross-sectional shape of the cylindrical lenses, the capabilities of precision offset printing are fully exhausted, and those of intaglio printing are almost fully exhausted.

In FIG. 4 it is assumed that in the microrefraction image the line pattern only has three lines with a width of two image points each. In this case, the limits of intaglio printing are not exhausted with line 14, but those of offset printing with line 16. As in FIG. 3, the ideal cross-sectional shape is illustrated in FIG. 4 with a continuous line. Less ideal cross-sectional shapes are illustrated with broken lines.

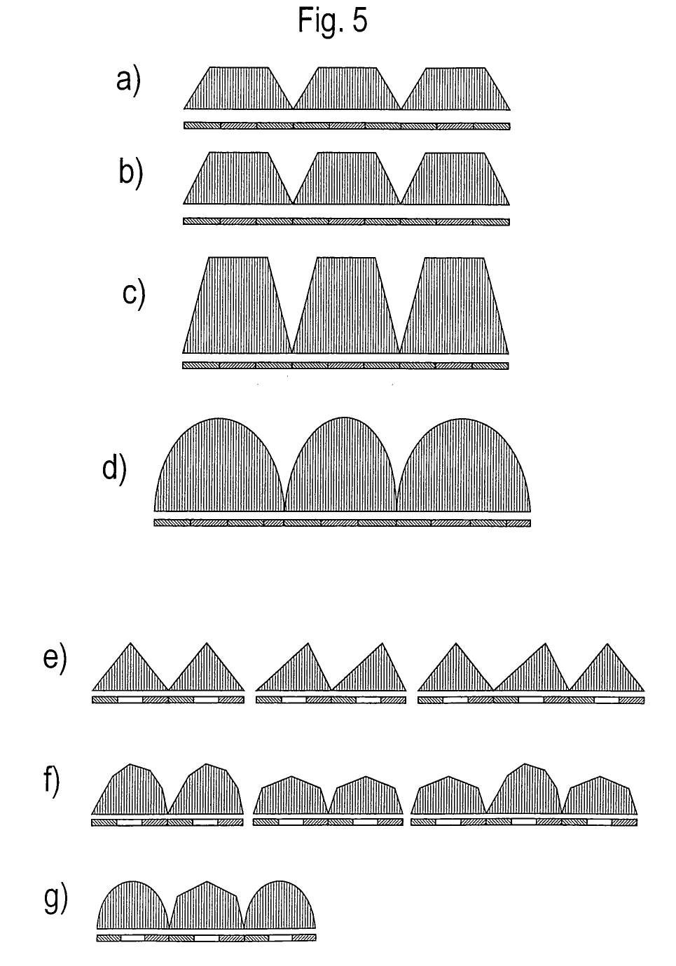

FIG. 5 shows cross-sectional shapes of the cylindrical lenses, with which special optical effects can be produced. FIG. 5a) shows a relatively flat prismatic cross-sectional shape, in particular a trapezoidal shape. FIG. 5b) shows the same trapezoidal shape with a greater apex height. The trapezoidal shapes shown in FIG. 5c) have an even greater apex height. With such lens structures, sudden changes of the image contents can be achieved with an only slightly changed viewing angle, the effect being perceptible even more distinctly with increasing apex height.

FIG. 5d) shows alternating cross-sectional shapes: one parabolic lens each is followed by an asymmetric cross-sectional shape, which is composed of strings of parabolas, again followed by a parabolic lens, etc. The effects to be achieved with such lens structures are very complex.

The lenses shown in FIG. 5e) have a triangular cross-sectional shape. The triangles can be equilateral or can have unequal sides or can also alternately be equilateral and inequilateral, as shown.

FIG. 5f) shows cylindrical lenses with the cross-sectional shape of a polygon, which can have equal or unequal sides, as shown.

FIG. 5g) shows cylindrical lenses with mixed cross-sectional shapes between prismatic and parabolic.

In general, it should be noted that the optical effects to be produced exhibit an increasing variety with increasing complexity of the cross-sectional shapes of the cylindrical lenses.

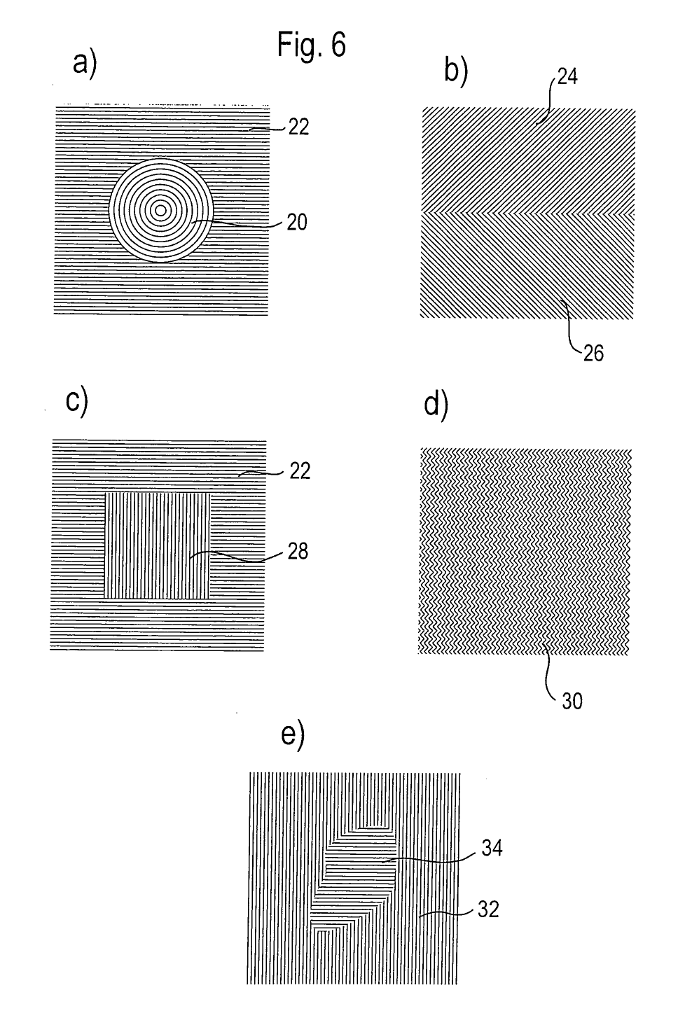

The optical effects to be achieved with the configurations of the lens structure as shown in FIG. 6 exhibit an even greater variety and complexity. In FIG. 6a), a circular surface region 20 of parallel circular lines is placed in an outer surface region 22 of straight lines. In FIG. 6b), there are two adjacent surface regions 24, 26 with line patterns rotated against each other by 90°. In FIG. 6c), a square region 28 of straight lines rotated by 90° lies within the outer surface region 22 of straight lines. In FIG. 6d), the lines in the surface region 30 have alternating directions, are undulated or serrated. In FIG. 6e), an irregularly shaped region 34 of straight lines rotated by 90° is arranged in an outer surface region 32 of straight lines. With such lens structures, which must be adjusted to the underlying line patterns, different optical effects are obtained, when the refraction image is swiveled about different axes or the viewing angle is changed in different planes.

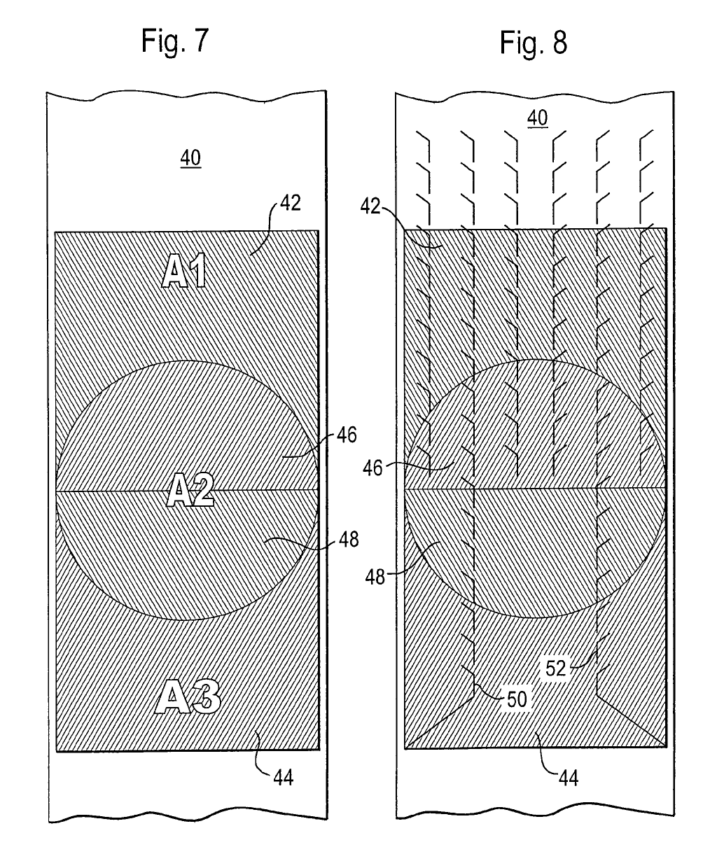

In the certificate of authenticity shown in FIG. 7, two flat safety elements 42 and 44 are arranged at a distance from each other on a substrate 40. The safety element 42 is symbolically represented by the designation “A1”, and the safety element 44 is represented by “A3”. Both safety elements 42, 44 are permanently connected with each other by transition zones 46, 48. Permanent connection here is understood to be an interaction between the safety elements 42, 44, which is provided by the transition zones by an effect of superposition. At least one of the safety elements 42, 44 is a microrefraction image as described above. The other safety element has a periodic structure, which is adjusted to that of the lens structure of the microrefraction image and at the same time is covered by the same with the line pattern of the microrefraction image. The permanent connection then can comprise an optical effect, e.g. a luminous strip, blinking points, bright flashing image elements or the like, which upon changing the viewing angle moves from the one safety element through the transition zones into the other safety element. While the one safety element is determined by a central certification authority, the other one can be determined by any third party (e.g. by a product manufacturer or product seller). The one safety element then is uniform, whereas the other one is variable.

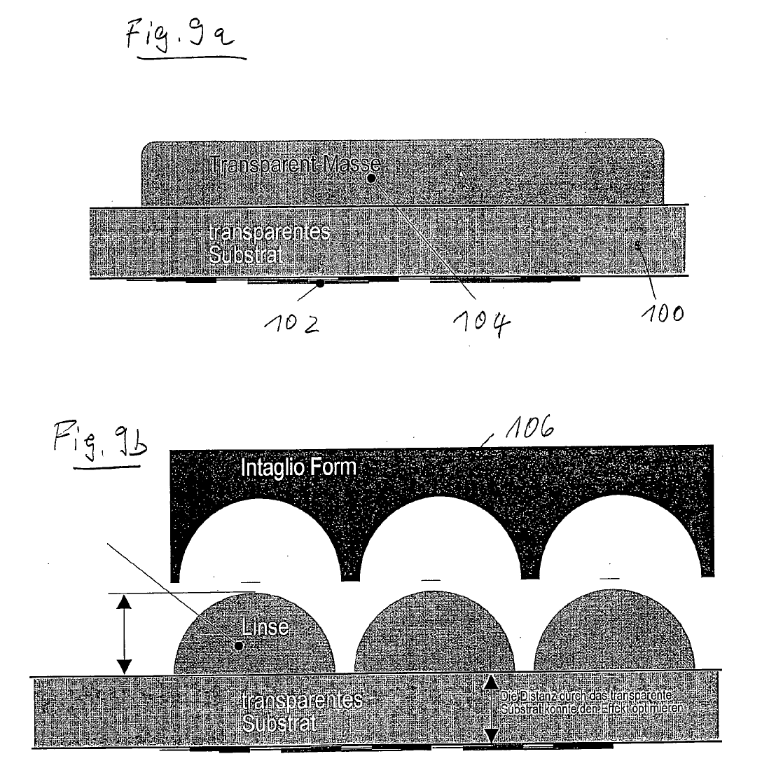

The certificate of authenticity shown in FIG. 7 can be used as an authentication seal, which is applied onto a product or package. Such authentication seal is shown in FIG. 8. At its back, the substrate 40 is coated with an adhesive. The safety elements and the transition zone therebetween are applied onto the substrate as a separate layer. To ensure a controlled destruction of the authentication seal when removing the same, perforation or punch lines extending in a longitudinal direction are provided along the desired tear lines. By using the tear lines, it can also be achieved that upon removal of the authentication seal from the product or from the package at least part of the seal remains intact.

In the embodiment shown in FIGS. 9a and 9b, a substrate 100 of a transparent material is used. On one of the surfaces of the substrate 100, the line pattern 102 is applied. On the surface facing away therefrom, a moldable transparent mass 104 is applied by a screen printing method. The transparent mass 104 then is embossed with an intaglio gravure plate 106 and formed into a lens structure. Alternatively, the lens structure can also be applied on the same surface as the line structure. However, the configuration shown in FIG. 9b, in which both structures are arranged on surfaces facing away from each other, has the advantage that the achievable optical effects are promoted by the spatial distance.

In accordance with a development it is finally also provided to arrange a line structure on both surfaces of the transparent substrate, the lens structure then being applied over one of the line structures. In this embodiment, an even greater variety of the optical effects is possible. In this embodiment, the two line structures are applied by simultaneous offset printing.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A microrefraction image, comprising:
a substrate,
a periodic line pattern applied on the substrate,
a periodic lens structure of cylindrical lenses parallel to lines of the periodic line pattern, which covers the periodic line pattern;
wherein
a period of the cylindrical lenses corresponds with a period of the periodic line
pattern,
the lines comprise paths of elementary printing dots,
a number of the paths of elementary printing dots in one period is at least four and not more than sixteen, and
a height of the cylindrical lenses at an apex lies in a range from about half a width of a period to about a full width of a period.

2. The microrefraction image according to claim 1, in which the cylindrical lenses are aligned flush with the lines of the periodic line pattern.

3. The microrefraction image according to claim 1, in which adjacent cylindrical lenses are spaced from each other.

4. The microrefraction image according to claim 3, in which a distance between adjacent cylindrical lenses corresponds to a width of a few elementary printing dots.

5. The microrefraction image according to claim 1, in which the periodic line pattern is applied by offset printing.

6. The microrefraction image according to claim 1, in which the periodic lens structure is applied from a transparent paste by intaglio printing.

7. The microrefraction image according to claim 1, in which the periodic lens structure is applied from a transparent paste by embossing with an intaglio gravure plate.

8. The microrefraction image according to claim 1, in which the cylindrical lenses have a semicircular to parabolic cross-sectional shape.

9. The microrefraction image according to claim 1, in which the cylindrical lenses have a prismatic cross-sectional shape.

10. The microrefraction image according to claim 1, in which the cylindrical lenses have a mixed prismatic/parabolic cross-sectional shape.

11. The microrefraction image according to claim 2, in which the lines in the periods of the periodic line pattern each have different colors.

12. The microrefraction image according to claim 2, in which the lines in the periods of the periodic line pattern have eliminated portions for representing image contents.

13. The microrefraction image according to claim 2, in which the periodic line pattern is applied on both sides of the substrate by simultaneous offset printing.

14. The microrefraction image according to claim 1, in which the substrate comprises a transparent material and the periodic line pattern is arranged on a surface of the substrate facing away from the periodic lens structure.

15. The microrefraction image according to claim 1, in which the periodic line pattern and the periodic lens structure have congruent surface regions, in which longitudinal direction of the lines or cylindrical lenses is different from the one in at least one other surface region.

16. The microrefraction image according to claim 1, in which an elementary printing dot has a side length of slightly more than an achievable printing resolution, in particular between 4 and 8 μm, in particular hardly more than 6 μm.

17. A method for producing a microrefraction image comprising the steps of:
imprinting a periodic line pattern on a substrate by offset printing,
applying a lens structure over the periodic line pattern in a transparent mass by printing or embossing with an intaglio gravure plate.

18. The method according to claim 17, in which for manufacturing a printing plate for simultaneous offset printing and for manufacturing a printing plate for intaglio printing the same dimensional basis is used.

19. The method according to claim 17, in which a laser exposure method is employed for manufacturing a printing plate for offset printing.

20. The method according to claim 17, in which a laser method with ablation in particular by evaporation directly on a surface of a printing plate is employed for manufacturing the intaglio gravure plate.

21. A certificate of authenticity with at least one safety element, which is applied on a substrate and has a periodic line structure, and with a periodic lens structure of parallel cylindrical lenses, which covers the safety element;
wherein
a period of the cylindrical lenses corresponds with a period of a line pattern,
the cylindrical lenses are aligned parallel to lines of the periodic line structure, and
a height of the cylindrical lenses at an apex lies in a range from about half a width of a period to about a full width of a period.

22. The certificate of authenticity according to claim 21, in which at least one safety element determined by a third party and one safety element determined by a central certification authority are arranged on the same substrate and the periodic lens structure at least partly extends over both safety elements.

23. The certificate of authenticity according to claim 22, in which at least one of the safety elements is a microrefraction image.

24. The certificate of authenticity according to claim 22, in which the two safety elements are connected by a transition zone, which provides a visually verifiable interconnection of the two safety elements.

25. The certificate of authenticity according to claim 21, comprising a plurality of layers, one of which is endowed with adhesion properties with respect to a product to be protected, and at least one further layer, whose removal will destroy the certificate of authenticity, is preperforated or prepunched along predetermined tear lines.
